(19) United States
(12) Patent Application Publication
(10) Pub. No.: US 2017/0253257 A1
(43) Pub. Date: Sep. 7, 2017

(54) RAIL VEHICLE HAVING AN EVENT-CONTROLLED DRIVER'S CAB DISPLAY DEVICE

(71) Applicant: SIEMENS AKTIENGESELLSCHAFT, MUNICH (DE)

(72) Inventors: ROLAND LOSKARN, FORCHHEIM (DE); ROLAND PORSCH, SPEICHERSDORF (DE)

(21) Appl. No.: 15/510,747

(22) PCT Filed: Sep. 9, 2015
(86) PCT No.: PCT/EP2015/070547

§ 371 Date: Mar. 13, 2017

(30) Foreign Application Priority Data
Sep. 12, 2014 (DE) 10 2014 218 341.3

(51) Int. Cl. B61L 15/00; G05B 19/042

(52) U.S. Cl. CPC B61L 15/009; G05B 19/0423; G05B 2219/25032; B61L 2201/00

(57) ABSTRACT

A rail vehicle has a set of operational subsystems and a driver's cab display device for displaying information to the driver of the vehicle. The driver's cab display device has at least one central display unit. The novel rail vehicle enables flexible and targeted outputting of information to the driver of the vehicle. For that purpose, the driver's cab display device has a control unit which is connected upstream of the display unit and which is provided to organize a dynamic information content, relating to multiple operational subsystems, for the display unit.

The invention relates to a rail vehicle having a set of operating means subsystems and a driver's cab display device for displaying information to the driver of the vehicle, which driver's cab display device has at least one central display unit.

The constant expansion of functionalities in the operation of rail vehicles has meant that the information content that will be displayed to the train driver is also increasing. This tendency is in contrast to further requirements relating to the layout of driver's cabs, which as a result of aerodynamic aspects in particular, are being made ever smaller, as well as relating to the attention that the driver must pay to the line. The reason for equipping drivers' areas with a plurality of display stations (also called HMI stations) lies in the fact that one display station is provided in each case for a number of operating means subsystems, the operation of which is based on an interaction with the train driver.

The underlying object of the invention is to provide a rail vehicle in which the aforementioned disadvantages can be reduced, in particular can be prevented.

To this end it is proposed that the driver's cab display device has a control unit connected upstream of the display unit, which is intended to regulate a dynamic information content for the display unit in relation to a number of operating means subsystems and for a regulation process of the control unit to comprise the checking of at least one condition and information handling as a function of the result of a check, wherein a condition of the regulation process relates to the occurrence of an operating event and the information handling comprises a display of information as a function of the result of a check, in particular of the result of the check. This enables a flexible and targeted display of information for the train driver in respect of functionalities implemented in the rail vehicle to be achieved. In particular the workload of the train driver can be reduced, wherein the attention that they are paying to the line can be significantly increased. In addition an ergonomic design of the driver's cab display device can be obtained. In particular, compared to known solutions, an advantageous reduction of device numbers and the cabling associated therewith can be achieved.

A “central” display unit is to be understood as a display unit of which the display surface, in relation to the width direction of the rail vehicle, is arranged centrally in said vehicle.

The display surface is especially embodied as a contiguous surface. This can be formed by a display screen unit that corresponds to a contiguous device unit—such as e.g. a built-in unit. As an alternative or in addition the display unit can have a display surface that is formed by a vehicle window, especially by a windscreen. In technical circles such a display surface is referred to as a headup display.

The width direction is aligned horizontally relative to the track bed and at right angles to the longitudinal direction of the rail vehicle. The central display unit is expediently arranged on the central plane of the vehicle, which is a vertical plane aligned in the longitudinal direction of the vehicle and dividing the vehicle into two halves. To use another formulation, the display unit intersects the central plane of the vehicle. The display unit is therefore advantageously located in the central area of a field of vision of a train driver looking in a direction of travel. The width direction is aligned at right angles to the central plane of the vehicle.

The control unit enables information to be displayed to the train driver predominantly by means of the central display unit. This is to be understood to mean that at least 50%, preferably at least 70% and especially advantageously at least 85% of the information flow, which is directed to the driver's cab display device in order to be reproduced by said device, will be displayed by means of the display unit.

The control unit, in relation to the direction of an information flow, which is directed from the operating means subsystems in the direction of the display unit, is “connected upstream” of the display unit.

A “dynamic” information content is to be understood especially as an information content that is able to be varied over time in relation to a type of information. It should accordingly be distinguished especially from an individual display variable, such as e.g. a speed variable, which changes over time and for which the display is continuously updated. The information content can be composed of different types of information, which are each assigned to different operating means subsystems, wherein the composition is variable over time.

A “regulation” is to be understood as a control, especially a creation and/or a management, which is undertaken in accordance with at least one predefined rule. To this end at least one regulation process of the control unit comprises the checking of at least one condition and information handling—especially a display of information by means of the central display unit—as a function of the result of a check.

A “result of a check” is to be understood as a result of checking the at least one condition.

Expediently the control unit includes an interface device with a set of interfaces that are each assigned to a different operating means subsystem. One or more interfaces can each be formed by a physical connection possibility. It is advantageous however for at least a predominant portion, especially the totality of the interfaces, to correspond to logical interfaces—also called logical ports.

Preferably the operating means subsystems belong to the group of systems that is formed by a train protection system, a door unit, an air conditioning device, a passenger information system, a video monitoring unit, an electronic working timetable unit with driver assistance function and a train-to-track communication unit.

An “operating event” is especially a phase of the operation of the rail vehicle. Specific phases are defined in advance for this for example. A condition of the regulation process here involves the rail vehicle entering a specific operating phase, such as e.g. a scheduled stop at a station, a journey phase, the start of a journey, a phase of calling at a station or a passenger pressing an emergency button.

It is proposed that the operating event is an event in the group formed by a scheduled stop at a station, a journey phase, the start of a journey, a phase of calling at a station or a passenger pressing an emergency button.

The fact that a regulation process of the control unit comprises the checking of at least one condition and handling of information as a function of the result of the check, wherein a condition of the regulation process involves the occurrence of an operating event and the information handling comprises displaying information as a function of the result of a check, means that a dynamic information content can advantageously be obtained, which will be displayed to the train driver in an information-triggered manner by means of the display unit. The information that they need for their operation and work at this point, especially for a current occurrence or an impending occurrence of the operating phase of the rail vehicle, can be displayed to the train driver especially advantageously at a specific point in time by means of the central display unit.

The condition that “involves” the occurrence of an operating event expediently represents a condition for a current occurrence or for an impending occurrence of the operating event. The at least one condition can itself be defined by a criterion or by a number of criteria, which are in particular operating parameters such as a position, a speed, a lighting condition, a weather parameter, an acceleration, the presence of a specific control signal etc.

A simple and fast regulation process can be achieved if the control unit has an interface via which, during operation, it accesses a database in which operating events are assigned at least one item of subsystem-related information in each case. The database can have at least fixed entries that cannot be changed by the train driver, wherein it is advantageous if at least one entry of the database is able to be configured by the train driver. The database can be stored in a memory unit of the rail vehicle, especially the control unit, wherein a land-side storage of the database and remote access by the control unit are likewise conceivable.

In addition a greater operating convenience for the train driver can be achieved if the information handling comprises the display of a subsystem-related operating mask. An “operating mask” is to be understood as a mask via which commands and/or data can be entered by the train driver. For operation of the operating mask an input device separate from the display surface can be provided—such as a keypad for example and/or the display surface can serve as the input device, in that the display unit is embodied as a touch-sensitive display (also called a touch screen). The operating mask or the operating masks which they need for their operation or work at this point in time, especially for the currently occurring or impending operating phase and needed for carrying out an application specific for this operating phase can be displayed to the train driver at a specific point in time by the central display device.

In an advantageous development of the invention it is proposed that a regulation process of the control unit comprises the checking of at least one condition and handling of information as a function of the result of a check, that the control has an interface via which, during operation, it accesses a database in which system-related information is assigned a priority level in each case, and a condition of the regulation process involves the existence of a priority level. This enables a dynamic information content to be obtained for the display unit, wherein an efficient and very largely conflict-free display of information of different operating means subsystems can be achieved.

An advantageously automated dynamic information content for the display unit can be achieved in this context if the control unit has an interface via which it accesses a database during operation in which priority levels are in each case assigned a handling process for handling the system-related information. A handling process in such cases can advantageously, depending on an assigned priority level, be an automatic display of the information by means of the display unit, making the information available with a displayed notification by means of the display unit or making the information available passively. When the information is displayed automatically, the information is shown on the display without any active involvement of the train driver. In the second case given, the notification is displayed automatically without any active involvement of the train driver being necessary, wherein the train driver needs to explicitly take action to retrieve the information. Making the information available “passively” means that the information is available for active retrieval by the train driver, wherein no notification is provided.

The priority levels that are assigned to the subsystem-related information can have fixed assignments, wherein priority levels assigned to at least one specific item of information in each case do not change. It is also conceivable however—for at least a part of the assigned priority levels—for the priority levels of this part to change over time. A condition of a regulation process of the control unit for changing the priority level can in this case especially involve the occurrence of an operating event and the corresponding information handling then corresponds to an event-triggered change in the priority level. If the priority levels themselves are each assigned to a handling process for handling the system-related information, this represents an advantageous possibility for obtaining an event-triggered display of system-related information.

It is also proposed that safety-related information is assigned a higher priority level compared to other information. “Safety-related information” is to be understood as information that has to be handled in accordance with safety requirements. The safety requirements are aimed in particular at the protection of persons. “Safety requirements” should be understood in particular as requirements that are defined in Standards EN 50128, 50159, 50126 and/or 50129. By the allocation of different priority levels in respect of safety aspects, a differentiated handling of safety-related information on the one hand and information related to comfort systems of the other hand can be achieved in the regulation of the dynamic safety content by the control unit.

The invention further relates to a method for output of information to a driver of a rail vehicle, which has a number of operating means subsystems, in which information is displayed by means of a display unit.

It is proposed that a dynamic information content related to a number of operating means subsystems is regulated for the display unit, that the dynamic information content is displayed by means of the display unit and during regulation of the information content at least one condition is checked and information is handled as a function of a result of the check, wherein the at least one condition involves the occurrence of an operating event and the information handling comprises displaying information as a function of the result of a check. For the advantageous effects of the inventive method the reader is referred to the information given above for the inventive rail vehicle.

Exemplary embodiments of the invention are explained in greater detail with reference to the drawings, in which:

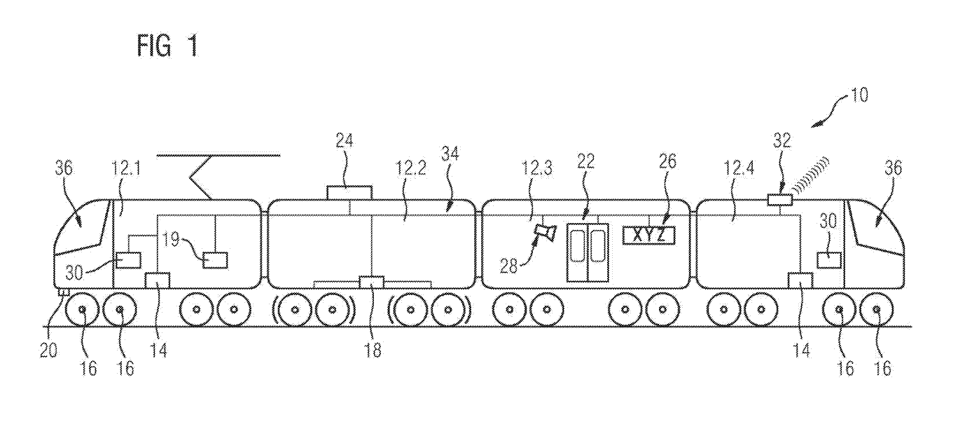

FIG. 1: shows a rail vehicle in a schematic side view,

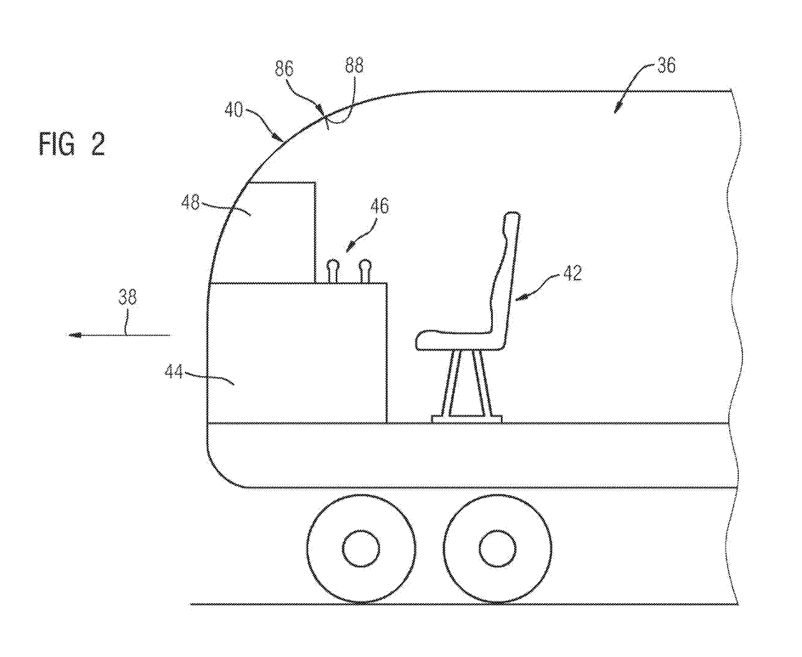

FIG. 2: shows a detailed view of a driver's area with a control desk,

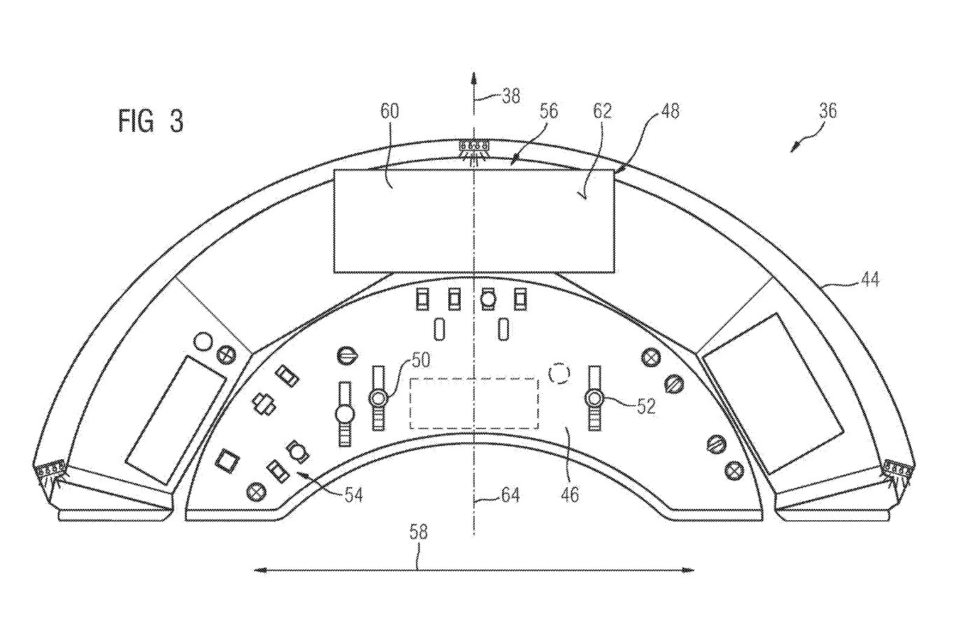

FIG. 3: shows the control desk with a display device in a view from above

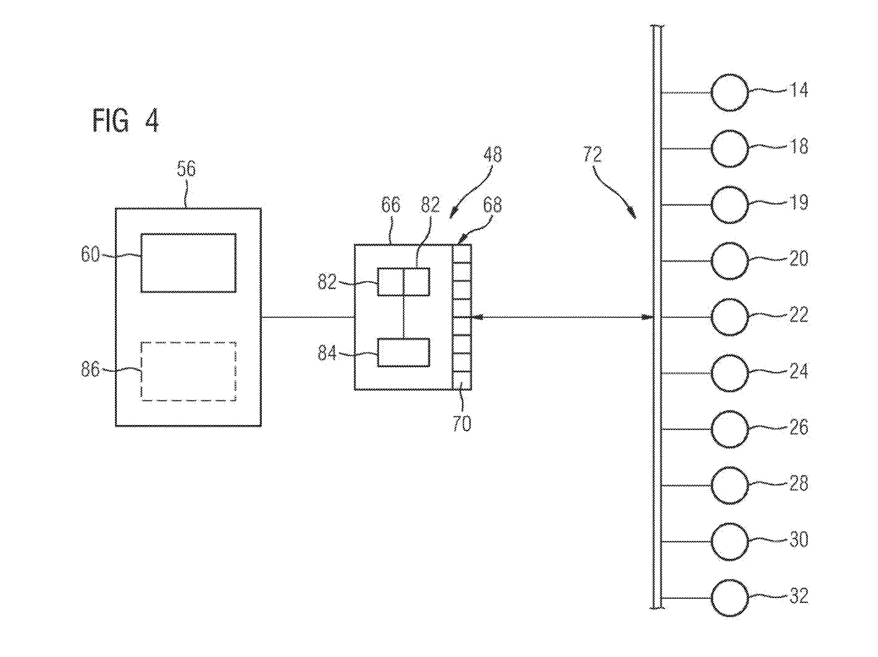

FIG. 4: shows a display device with a control unit and operating means subsystems of the rail vehicle,

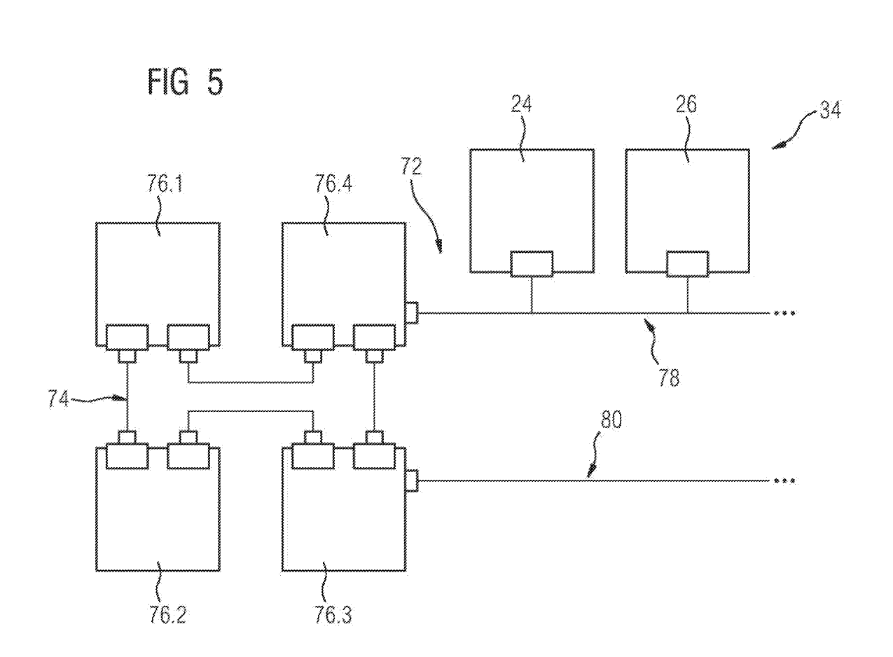

FIG. 5: shows a data bus structure of the rail vehicle and

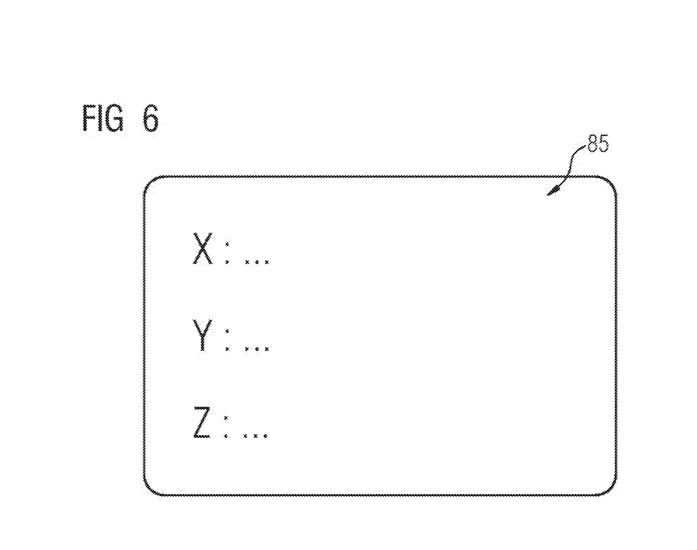

FIG. 6: shows an operating mask

FIG. 1 shows a rail vehicle 10 in a schematic view from the side. The rail vehicle 10 is embodied as an association of a number of cars 12, which are coupled mechanically to one another and which form a train unit. In the configuration considered the rail vehicle 10 is embodied as what is referred to as a multiple unit train. To this end at least one of the cars 12 of the association is provided with a drive unit 14 for driving a drive axle 16. The drive unit 14 has a power supply unit, which especially by means of power electronics generates electric power for an electric motor (not shown). In a further configuration it is conceivable for the rail vehicle 10 to be embodied as a single traction unit. In addition the rail vehicle 10 can also be embodied as a locomotive.

It is known that the rail vehicle 10 has a number of operating means that make it possible to operate the vehicle 10. A set of functionally-connected operating means that are assigned to a specific functionality is also called an “operating means subsystem” (also just “subsystem” in this text). In FIG. 1 operating means of the following operating means subsystems are shown by way of example: Components of the drive unit (subsystem 14), of a brake device (subsystem 18, shown by way of example and schematically in car 12.2), of a vehicle controller (subsystem 19), of a train protection system (subsystem 20), of a door unit (subsystem 22, shown by way of example and schematically in car 12.3), of an air conditioning device (subsystem 24), of a passenger information system (subsystem 26), of a video monitoring unit (subsystem 28), of an electronic working timetable unit with driver assistance function (subsystem 30) and of a train-to-track communication unit (subsystem 32). Operating means of the vehicle 10 can generally be embodied as a control unit, a sensor unit and/or actuator unit. The operating means that are installed in rail vehicle 10 and are therefore permanently linked to the vehicle structure are networked with one another and are thereby components of a data network 34 shown greatly simplified in FIG. 1

In addition the rail vehicle 10 is equipped in each head car in each case with a driver's cab 36, which will be described below.

FIGS. 2 and 3 show the driver's cab 36 in a schematic diagram. Viewed in the direction of travel 38, it is arranged behind the vehicle window 40, embodied as the windscreen, of the respective front car. It is equipped with a seating facility 42 for the vehicle driver and a control desk 44, which serves as a carrier unit for a driver's cab actuation device 46 and a driver's cab display device 48. It is known that the driver's cab actuation device 46 has a set of operating means (see FIG. 3) via which the vehicle driver can enter various control commands. Typical control commands are the entry of a traction stage by means of a first operating means 50 embodied as an operating lever and the entry of a braking stage by means of a further operating means 52 embodied as an operating lever. Via further operating means 54 embodied as push buttons the vehicle driver can handle an acknowledgement process requested by the train protection system (e.g. PZB acknowledgement). The control desk 44 is equipped with further operating means not described individually in any greater detail.

The driver's cab display device 48 has a central display unit 56, which has a display screen unit 60 arranged centrally in relation to the direction 58 of the width of the rail vehicle 10. The display screen unit 60 is arranged—in relation to the direction 58 of the width of the rail vehicle 10—between the operating means 50, 52 for traction and braking, wherein the display screen unit 60 is offset relative to the operating means 50, 52 in the direction of travel 38. The display screen unit 60 forms a contiguous display surface 62, which is located in the field of view of a seated vehicle driver looking in the direction of travel 38. The display surface 62 is located here on the vehicle central plane 64, which extends in the direction of travel 38—or longitudinal direction of the rail vehicle 10—or the display surface 62 is intersected by the vehicle central plane 64. The display surface 62 is accordingly arranged centrally in the control desk 44.

FIG. 4 shows a schematic diagram of a circuit of the rail vehicle 10. The operating means subsystems 14, 18, 19 as well as 20 to 32 described above are shown schematically. Furthermore the driver's cab display device 48 is shown, which features the display unit 56 with the display screen unit 60 and a control unit 66 for controlling the display unit 56. The control unit 66 has an active connection to the display unit 56 for control of said unit. It is also connected via an interface device 68 to the operating means subsystems described above for exchange of data. To this end it has a set of interfaces 70, each of which is assigned to a different operating means subsystem. The interfaces 70 in this case can correspond to physical connection options, such as e.g. plug-in options, and/or they can also correspond to logical connections, such as in the form of logical ports for example. In the latter, preferred option the control unit 66 is connected to a data bus structure 72, through which the operating means subsystems are networked with one another.

The data bus structure 72 is shown as a highly schematic diagram in FIG. 4. A typical configuration of the data bus structure 72 is shown in FIG. 5. The data bus structure 72 has a ring 74, which connects control devices 76.1 to 76.4, especially stored program controls, to one another. The ring 74 is based in particular on Ethernet technology and can be embodied as a Profinet® ring for example. In an alternate configuration the data bus structure 72 can have a CAN bus. Connected to the ring 74 via a data bus 78 of the data bus structure 72 connected to the ring 74 are operating means systems 24, 26 shown by way of example. The bus 78 can e.g. correspond to the known MVB bus. Also connected to the ring 74 can be a train bus 80 of the data bus structure 72 extending along the entire association of cars 12, such as e.g. a WTB bus or ETB bus.

The control unit 66—as set out in detail below—is intended to regulate a dynamic information content related to a number of operating means subsystems for the display unit 56.

To this end the control unit 66 has a processing unit 82 with at least one processor and a memory unit 84, in which software modules are stored. Programmed into at least one software module is a regulation process, in which the following method steps are carried out:
Checking step, in which the fulfilment of at least one condition is checked and
Information handling as a function of the result of the check.

Information handling, which is done in accordance with rules that are based on the specification of conditions, is controlled by the control unit 66. Information is accordingly output dynamically by means of the display unit 56, depending on parameters that are evaluated by the control unit 66.

In particular the information handling comprises an event-triggered display of information, in that a condition of the regulation process involves the occurrence of an operating event. Here the rules include the linkage of operating events to one or more display processes, which are carried out when a specific operating event is recognized by the control unit 66 as having occurred.

The event-triggered control of the display unit 56 is based on an assignment table of a database, which is stored in the memory unit 84 and is shown below. In this assignment table predefined operating events are assigned in each case to at least one item of subsystem-related information:

| Operating event | Information |
|---|---|
| Scheduled stop at a station | Images of subsystem 28 - |
| | monitoring of passenger |
| | compartments |
| Scheduled stop at a station | Operating mask “technical |
| | diagnosis display” of |
| | subsystem 19 - release of the |
| | doors |
| Journey phase | Images of subsystem 28 - |
| | Front camera |
| Journey phase | Journey recommendations |
| | subsystem 30 |
| Actuation of an emergency | Images of subsystem 28 - |
| button by a passenger | camera that is assigned to |
| | the emergency station. |
| Start of the journey | Operating mask of subsystem |
| | 19 |
| Phase of calling at a station | Operating panel of subsystem |
| | 26 - selection and playing of |
| | announcements |
| — | — |

The recognition of the occurrence of an operating event can itself occur through the checking of a number of conditions. Thus for example the operating event “scheduled stop at a station” can be detected by the condition “speed of the vehicle falling below a predetermined threshold value” (e.g. 5 km/h) and “impending, scheduled stop at a station”, which can be taken from subsystem 30.

The display process that is triggered by the fulfilment of the condition “occurrence of the operating event X” then includes the display of the information assigned to this operating event X in accordance with the database.

This display process in particular includes an automatic incorporation of the assigned information into the display screen unit 60. Thus for example, if the operating event “scheduled stop at a station” is present, the images of the video monitoring unit (subsystem 28) in the area of the doors will be incorporated automatically into the display. While the rail vehicle 10 is at a standstill at the station the images of the video cameras remain displayed. In the departure phase the exceeding of the speed threshold value described above is checked by the control unit 66. If the operating event “scheduled stop at a station” is recognized thereby as no longer being currently present, an automatic hiding of the camera images in the display screen unit 60 is triggered by the control unit 66.

In addition, if the operating event “scheduled stop at a station” is present, an operating mask of the subsystem 19 is incorporated automatically, via which release and locking of the doors can be carried out by the train driver. The operating mask corresponds to the “technical diagnosis display” of the prior art. If the operating event is no longer present, the operating mask is hidden.

For operating event “journey phase” there is an automatic incorporation of the image information of subsystem 28 (“video monitoring unit”), especially from front cameras, and a marking of obstacles that are on the track. These display processes can be linked to further events that are related to a weather condition and/or a lighting condition. This image information is hidden automatically during the operating event “phase of calling at a station”.

During the operating event “journey phase” there is an automatic display of driving recommendations of a driver assistance system of subsystem 30 (“electronic working timetable unit”). On exit from this operating event, e.g. when the rail vehicle 10 is in the “phase of calling at a station”, this image information is hidden on the display automatically.

For operating event “start of the journey” the aforementioned operating mask “technical diagnosis display” of subsystem 19 (“vehicle control”) is shown automatically, by which the train driver is requested to enter a vehicle number and further parameters and by means of which they can make these entries. An example of a version of such an operating mask 85 is shown in FIG. 6.

The assignment table shown above is advantageously able to be configured by the end user, wherein, as well as settings that cannot be changed, further links between operating events and specific information of the subsystems can be defined.

A condition for a regulation process of the control unit 66 can also be the presence of a priority level, which is assigned to specific subsystem-related information.

To this end the database stored in the memory unit 84 comprises an assignment table, which is shown below:

| Information | Priority level |
|---|---|
| Messages of subsystem 14 | High |
| Messages of subsystem 18 | High |
| Messages of subsystem 24 | Medium |
| Messages of subsystem 26 | Low |
| Messages of subsystem 30 | Low |
| . . . | . . . |

A checking step based on the priority level is of advantage especially for information for which there is no direct assignment to a specific operating event, especially one that is defined in the database. This predominantly involves messages created by the subsystems about the state of operating means, which can be created per se at any time—i.e. in any operating phase.

In an example, while the rail vehicle 10 is halted at a station, a message of a diagnosis device will be created. This is a component of subsystem 24 (“air conditioning device”) and signals that a ventilation unit in the subsystem is defective. This information is assigned the priority level “medium”. The control unit 66 checks for the presence of a specific priority level for this information and assigns specific information handling.

To this end the database has an assignment table, which is shown below:

| Priority level | Handling of the information |
|---|---|
| High | Automatic display by means of |
| | the display unit 56 |
| Medium | Making the information |
| | available with automatic |
| | notification by means of the |
| | display unit 56 |
| Low | Making the information |
| | available without automatic |
| | notification |

The handling process specified in the second line includes the automatic incorporation of a notification for the train driver, which informs them that the information can be retrieved. The information itself can be retrieved by an active operation of the control panel by the train driver. Accordingly it is left to the train driver as to whether the content of the message is displayed to them by means of the display unit 56.

In a further example, during a journey phase of the rail vehicle 10, messages from different diagnostic devices will be created. The first diagnostic device is a component of subsystem 14 and is assigned to a drive control device. This creates the message “drive motor 1—car 29 failed”. The further message corresponds to the message described above about the failure of a ventilation unit in subsystem 24. The control unit 66 evaluates the priority level assigned in each case and makes a decision on the basis thereof about the display process to be initiated. The first message is assigned the priority level “high”, so that the control unit 66 triggers an automatic display of the information about the failure of the drive motor. In relation to the message of subsystem 24, which is assigned the priority level “medium”, a notification is shown in the display as described above.

System-related information, which, as described above, is assigned to at least one operating event, can also be assigned to a priority level in each case. In a further example driving recommendations of the driver assistance system are displayed during a journey phase of the rail vehicle 10 as described above. If the above-mentioned message relating to the failure of the drive motor is created, this message is superimposed in the display on the driving recommendations. This is achieved by the message created by subsystem 14 (“drive unit”) being assigned a higher priority level than the driving recommendations of the subsystem 30 (“electronic working timetable unit”). The message relating to the failure of the drive motor should however not be superimposed on any displayed information that is likewise assigned the priority level “high”. Accordingly information can only be superimposed on information that has a lower priority level.

Of the information that is communicated in the rail vehicle 10 and in its environment, the highest priority level is assigned to the information that is safety-related. In technical terms this information, which is relevant for personal protection, will also be referred to as safety-relevant information. This involves information or data for which communication is subject to standardized requirements. In particular a safety-conformant data transmission is defined in Standards EN 50128, 50159, 50126 and/or 50129. Through the assignment of the highest priority level to safety-relevant information, after evaluation by the control unit 66, the information is incorporated automatically into the display of the display screen unit 60. Since the display processes initiated by the control unit 66 in relation to safety-related information also correspond to a communication process of safety-related information, it is likewise subject to the above-mentioned requirements. Accordingly the control unit 66 must be designed for safety. In particular it is a redundant design. This can be achieved by it being equipped with two processing units—e.g. two processor cores—as indicated in FIG. 4, wherein the control processes of the control unit 66 are redundant in diverse ways. For example the control processes will be programmed in each case with two different algorithms.

In the exemplary embodiment considered above the display unit 56 has the display screen unit 60 embodied as a screen, wherein display processes are carried out by means of the display screen unit 60. As an alternative or in addition the display unit 56 has a display means 86, for which the vehicle window 40 formed by the windscreen forms a display surface 88. This optional version of the display unit 56 with the display means 86—also referred to as a heads-up display in technical circles—is shown by a dashed outline in FIG. 4 (see also FIG. 1).

1-14. (canceled)

15. A rail vehicle, comprising:
a set of operating means subsystems;
a driver's cab display device for displaying information to a vehicle driver, said driver's cab display device including:
at least one central screen unit;
a control unit connected upstream of said screen unit and configured to regulate a dynamic information content related to a number of said operating means subsystems for said screen unit;
wherein said control unit is configured to carry out a regulation process including a checking of at least one condition and information handling in dependence on a result of a check, wherein a condition of the regulation process includes an occurrence of an operating event and the information handling includes displaying information in dependence on the result of the check.

16. The rail vehicle according to claim 15, wherein said control unit has an interface device with a set of interfaces each assigned to a respectively different operating means subsystem.

17. The rail vehicle according to claim 15, wherein said operating means subsystems are selected from the group consisting of a train protection system, a door unit, an air conditioning device, a passenger information system, a video monitoring unit, an electronic working timetable unit with driver assistance function, and a train-to-track communication unit.

18. The rail vehicle according to claim 15, wherein the operating event is an event selected from the group consisting of a scheduled stop at a station, a journey phase, a start of a journey, a phase of calling at a station, and an actuation of an emergency trigger by a passenger.

19. The rail vehicle according to claim 15, wherein said control unit has an interface via which, during operation, said control unit accesses a database in which operating events are assigned at least one item of system-related information in each case.

20. The rail vehicle according to claim 15, wherein the information handling includes the display of a subsystem-related operating mask.

21. The rail vehicle according to claim 15, wherein:
a regulation process of the control unit includes the checking of at least one condition and information handling as a function of the result of a check;
said control unit has an interface via which, during operation, said control unit accesses a database in which system-related information is assigned a priority level in each case; and
a condition of the regulation process involves the presence of a priority level.

22. The rail vehicle according to claim 21, wherein said control unit has an interface, via which, during operation, said control unit accesses a database in which priority levels are assigned a handling process for handling the subsystem-related information in each case.

23. The rail vehicle according to claim 21, wherein an assigned handling process dependent on the priority level is an automatic display of the information by way of said screen unit, a making the information available with a displayed notification by way of said screen unit or making the information available passively.

24. The rail vehicle according to claim 21, wherein safety-related information is assigned a higher priority level compared to other information.

25. The rail vehicle according to claim 15, wherein said screen unit comprises at least one display surface formed by a vehicle window.

26. A method for outputting information to a driver of a rail vehicle, the rail vehicle having a plurality of operating means subsystems and a screen unit for displaying the information, the method comprising:
regulating a dynamic information content related to a plurality of operating means subsystems for the screen unit;
displaying the dynamic information content by way of the screen unit;
while regulating the information content, checking for at least one condition, the condition being an occurrence of an operational event; and
selectively displaying the information in dependence on a result of the checking step.

27. The method according to claim 26, which comprises displaying a subsystem-related operating mask during information handling.

28. The method according to claim 26, which comprises assigning priority levels to the subsystem-related information, during regulation of the information content checking at least one condition and information handling takes place as a function of the result of the check and the at least one condition involves the presence of a priority level.
